(19) United States
(12) Patent Application Publication
(10) Pub. No.: US 2019/0199423 A1
(43) Pub. Date: Jun. 27, 2019

(54) EFFICIENT SEARCH THROUGH AN ANTENNA-PATTERN GROUP

(71) Applicant: ARRIS Enterprises LLC, Suwanee, GA (US)

(72) Inventor: Peter Khoury, San Francisco, CA (US)

(21) Appl. No.: 16/329,763

(22) PCT Filed: Aug. 29, 2016
(86) PCT No.: PCT/US2016/049279

§ 371 Date: Feb. 28, 2019

(51) Int. Cl. H04B 7/06

(52) U.S. Cl. CPC H04B 7/0695; H04W 84/12; H04B 7/063

(57) ABSTRACT

An access point may utilize a fast search through a set of antenna patterns to select antenna patterns for multiple antennas in the access point. During the search, the access point may transmit frames while varying, over the set of antenna patterns, an antenna pattern of a first antenna in the access point that is being processed and setting remaining antennas in the access point that have not been processed to a fixed antenna pattern. Based on feedback received from the electronic device, the access point may select a first antenna pattern for the first antenna. Then, the operations may be repeated, independently, for the remaining antennas, while a subset of the antennas (which includes the first antenna) that have already processed are set to their selected antenna patterns and another subset of the antennas that have not already processed may be set to the fixed antenna pattern.

### FIELD

The described embodiments relate to techniques for communicating information among electronic devices. In particular, the described embodiments relate to techniques for efficiently searching through a set of antenna patterns by independently selecting antenna patterns for the antennas.

### RELATED ART

Many electronic devices are capable of wirelessly communicating with other electronic devices. In particular, these electronic devices can include a networking subsystem that implements a network interface for: a cellular network (UMTS, LTE, etc.), a wireless local area network (e.g., a wireless network such as described in the Institute of Electrical and Electronics Engineers (IEEE) 802.11 standard or Bluetooth from the Bluetooth Special Interest Group of Kirkland, Wash.), and/or another type of wireless network. For example, many electronic devices communicate with each other via wireless local area networks (WLANs) using an IEEE 802.11-compatible communication protocol (which are sometimes collectively referred to as ‘Wi-Fi’).

Moreover, many Wi-Fi-based access points include multiple antennas, each of which may have its own associated antenna pattern. When the multiple antennas in an access point are viewed as a whole, the potential antenna patterns of the antennas is referred to as a set of antenna patterns (or, sometimes, as a ‘group of antenna patterns’ or an ‘antenna-pattern group’). During setup or operation of the access point, the antenna patterns for the individual antennas are often dynamically selected from the set of antenna-patterns.

However, determining appropriate antenna patterns for the antennas can be challenging. In particular, when there are multiple antennas that each have multiple possible antenna patterns, the dimensionality of the search space can be quite large. For example, if there are four antennas that each can have one of seven possible antenna patterns, the set of antenna patterns includes 7⁴ or 2401 possible configurations. Searching through the different configurations to determine an optimal configuration is typically time consuming and difficult.

In addition, because of resource constraints (such as available memory during the search), many access points fix the antenna pattern of at least one of the antennas as omnidirectional and/or reduce the number of possible antenna patterns to four. While this approach simplifies the problem by reducing the search space to 4³ or 64 possible configurations, the antenna patterns that are selected are often suboptimal.

Consequently, the difficulty in searching through the set of antenna patterns may result in long delays and/or may adversely impact the communication performance of a WLAN, and thus may degrade the user experience when communicating in a WLAN via Wi-Fi.

### SUMMARY

The described embodiments relate to an access point that facilitates improved service in a wireless local area network (WLAN) that includes the access point. This access point includes nodes (such as electrical connections) that can couple to multiple antennas and an interface circuit that, during operation, communicates with an electronic device. Moreover, the access point searches through a set of antenna patterns that includes possible antenna patterns to select for the antennas. In particular, while transmitting frames to the electronic device during the search, the access point varies, over the set of antenna patterns, an antenna pattern of a first antenna in the access point that is being processed and sets remaining antennas in the access point that have not been processed to a fixed antenna pattern (such as an omnidirectional antenna pattern). Based on feedback received from the electronic device, either directly or indirectly (e.g., via a packet error), the access point selects a first antenna pattern for the first antenna. Then, the transmitting, the varying, the receiving and the selecting may be repeated, independently, for the remaining antennas, while a subset of the antennas (which includes the first antenna) that have already processed are set to their selected antenna patterns and another subset of the antennas that have not already processed are set to the fixed antenna pattern or a different fixed antenna pattern.

Note that the feedback may include acknowledgements frames (and/or the absence of acknowledgment frames) that indicate whether transmitted frames were successfully received by the electronic device. Moreover, the feedback may include information that specifies communication performance during the communication.

Furthermore, the access point may use transmit beamforming when the frames are transmitted to the electronic device. Therefore, at least some of the frames may include sounding information. Additionally, the feedback may include beamforming steering matrices. The access point may use the beamforming steering matrices to determine phases associated with the antennas, which are subsequently used during communication with the electronic device.

In some embodiments, the interface circuit performs at least some of the operations performed by the access point during the search. Alternatively or additionally, may include: a processor; and a memory, coupled to the processor, which stores a program module that, during operation, is executed by the processor. The program module may include instructions for at least some of the operations performed by the access point during the search.

Note that the antenna patterns selected for the antennas may be optimal. For example, the antenna patterns may achieve approximately optimal communication performance during communication with the electronic device, such as communication performance within 5, 10 or 20% of the maximum communication performance.

Moreover, the access point may include the antennas.

In some embodiments, when the operations are repeated, the antennas that have been processed may be set to the fixed antenna pattern. After the antenna patterns for all the antennas have been selected, then these antenna patterns may be used when the access point is communicating frames.

Another embodiment provides a computer-program product for use with the access point. This computer-program product includes instructions for at least some of the operations performed by the access point.

Another embodiment provides a method. This method includes at least some of the operations performed by the access point.

Another embodiment provides the interface circuit.

Another embodiment provides the electronic device that performs counter-part operations to those performed by the access point.

Another embodiment provides a computer-program product for use with the electronic device. This computer-program product includes instructions for at least some of the operations performed by the electronic device.

Another embodiment provides a method. This method includes at least some of the operations performed by the electronic device.

This Summary is provided merely for purposes of illustrating some exemplary embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a drawing illustrating communication among an access point and an electronic device in a wireless local area (WLAN) in accordance with an embodiment of the present disclosure.

FIG. 2 is a flow diagram illustrating a method for searching through a set of antenna patterns in accordance with an embodiment of the present disclosure.

FIG. 3 is a drawing illustrating communication between the access point and the electronic device in FIG. 1 in accordance with an embodiment of the present disclosure.

FIG. 4 is a drawing illustrating a search through a set of antenna patterns in accordance with an embodiment of the present disclosure.

FIG. 5 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

An access point may utilize a fast search through a set of antenna patterns to select antenna patterns for antennas in the access point. During the search, the access point may transmit frames while independently varying an antenna pattern of a first antenna and setting the remaining antennas to a fixed antenna pattern (such as an omnidirectional antenna pattern). Then, the access point may select a particular antenna pattern for the first antenna based on feedback from an electronic device that received the frames. These operations may be repeated for the remaining antennas, while antennas that have already been processed are set to their selected antenna patterns and unprocessed antennas that are not currently being processed are set to the fixed antenna pattern.

By systematically and independently selecting the appropriate antenna patterns for the antennas, this search technique may allow the entire search space to be considered in an efficient manner. Consequently, the search technique may reduce the time and the complexity of selecting the antenna patterns, and may allow the communication performance of the access point to be optimized. In the process, the search technique may improve the communication performance of the access point and, thus, may improve the user experience when communicating in a WLAN via Wi-Fi.

In the discussion that follows, the electronic device and the access point communicate packets in accordance with a communication protocol, such as an Institute of Electrical and Electronics Engineers (IEEE) 802.11 standard (which is sometimes referred to as ‘Wi-Fi,’ from the Wi-Fi Alliance of Austin, Tex.), Bluetooth (from the Bluetooth Special Interest Group of Kirkland, Wash.), and/or another type of wireless interface. In the discussion that follows, Wi-Fi is used as an illustrative example. However, a wide variety of communication protocols (such as Long Term Evolution or LTE, another cellular-telephone communication protocol, etc.) may be used.

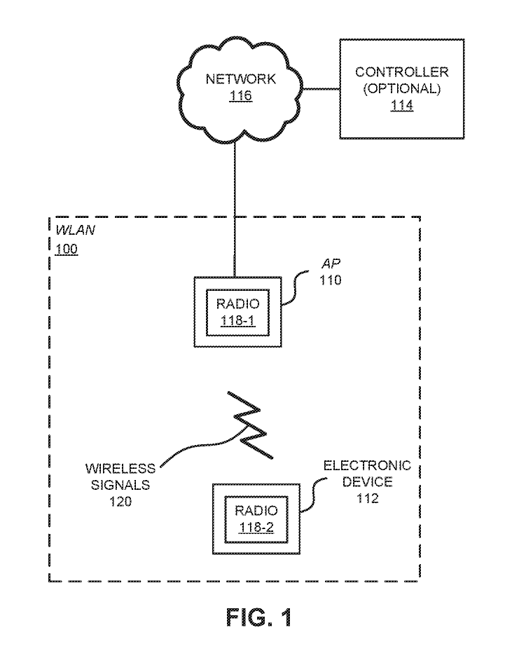

FIG. 1 presents a drawing illustrating communication among access point (AP) 110 and an electronic device 112 (such as a cellular telephone) in a WLAN 100 in accordance with some embodiments. In particular, access point 110 may communicate with electronic device 112 using wireless communication (such as using Wi-Fi), and access point 110 may communicate with optional controller 114 via network 116, such as the Internet. (However, in some embodiments, optional controller 114 is a virtual controller, such as a controller than is implemented in software in an environment on a server.). Therefore, access point 110 may provide wirelessly communication with one or more electronic devices (such electronic device 112), and may provide access to network 116 via IEEE 802.3 (which is sometimes referred to as ‘Ethernet’).

Moreover, the wireless communication using Wi-Fi may involve: transmitting advertising frames on wireless channels, detecting one another by scanning wireless channels, establishing connections (for example, by transmitting association or attach requests), and/or transmitting and receiving packets (which may include the association requests and/or additional information as payloads).

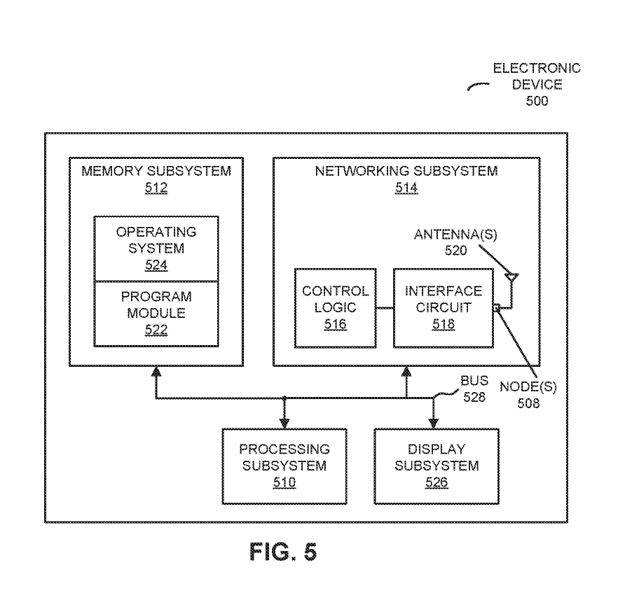

As described further below with reference to FIG. 5, access point 110, electronic device 112, and/or optional controller 114 may include subsystems, such as a networking subsystem, a memory subsystem and a processor subsystem. In addition, access point 110 and electronic device 112 may include radios 118 in the networking subsystems. More generally, access point 110 and electronic device 112 can include (or can be included within) any electronic devices with the networking subsystems that enable access point 110 and electronic device 112 to wirelessly communicate with each other. This wireless communication can comprise transmitting advertisements on wireless channels to enable access points and/or electronic devices to make initial contact or detect each other, followed by exchanging subsequent data/management frames (such as association requests and responses) to establish a connection, configure security options (e.g., Internet Protocol Security), transmit and receive packets or frames via the connection, etc. Note that while instances of radios 118 are shown in access point 110 and electronic device 112, one or more of these instances may be different from the other instances of radios 118.

As can be seen in FIG. 1, wireless signals 120 (represented by a jagged line) are transmitted from radio 118-1 in access point 110. These wireless signals may be received by radio 118-2 in electronic device 112. In particular, access point 110 may transmit packets. In turn, these packets may be received by electronic device 112. Moreover, access point 110 may allow electronic device 112 to communicate with other electronic devices, computers and/or servers via network 116.

Note that the communication between access point 110 and electronic device 112 may be characterized by a variety of performance metrics, such as: a received signal strength (RSSI), a data rate, a data rate for successful communication (which is sometimes referred to as a ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’).

In the described embodiments processing a packet or frame in access point 110 and electronic device 112 includes: receiving wireless signals 120 with the packet or frame; decoding/extracting the packet or frame from received wireless signals 120 to acquire the packet or frame; and processing the packet or frame to determine information contained in the packet or frame.

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

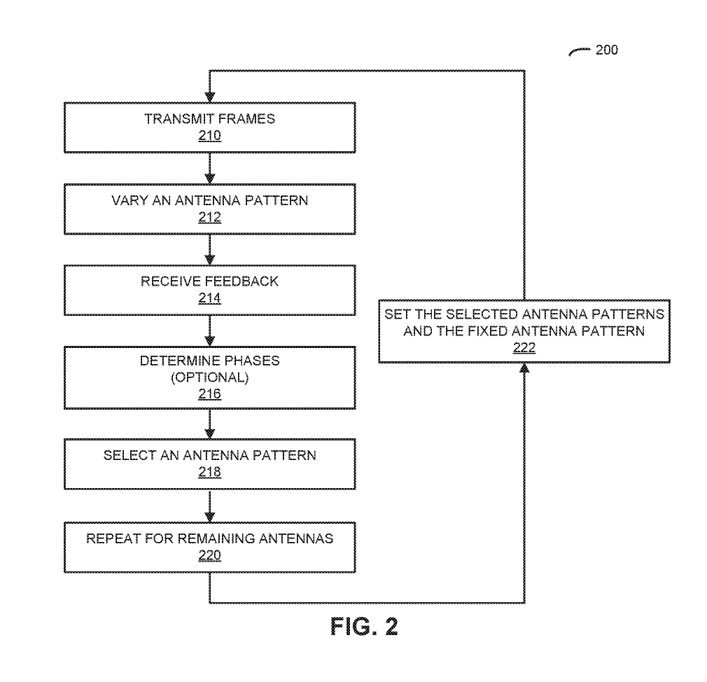

We now further describe communication in WLAN 100. Access point 110 (and, in some embodiments, electronic device 112) may include multiple antennas. Each of these antennas may have associated possible antenna patterns that collectively (for the antennas) are referred to as a set of antenna patterns, and particular antenna patterns for the antennas may be selected from the set of antenna patterns. In particular, each of the antennas may be configurable or adaptable, so the antenna may have multiple potential antenna patterns. Alternatively, each of the antennas may be configurable or adaptable, so the antenna may have two or more antenna patterns at a given time. Instead of concurrently varying the antenna patterns, as described further below with reference to FIGS. 2-4, during operation access point 110 may sequentially and independently select the antenna pattern for each of the antennas based on the environment or the radio-frequency (RF) neighborhood (such as a location of electronic device 112 relative to access point 110) and the communication performance.

In particular, while transmitting frames to electronic device 112 during the search, access point 110 may vary, over the set of antenna patterns, an antenna pattern of a first antenna in access point 110 that is being processed (or optimized)) and may set remaining antennas in access point 110 that have not been processed to a fixed antenna pattern (such as an omnidirectional antenna pattern, however another antenna pattern may be used). Based on feedback received from electronic device 112, access point 110 may select a first antenna pattern for the first antenna. Then, the transmitting, the varying, the receiving and the selecting may be repeated, independently, for the remaining antennas, while a subset of the antennas (which includes the first antenna) that have already been processed are set to their selected antenna patterns and another subset of the antennas that have not already been processed may be set to the fixed antenna pattern.

Note that the feedback may include acknowledgements frames (and, more generally, implicit feedback) that indicate whether transmitted frames were successfully received by electronic device 112. Moreover, the feedback may include information that specifies communication performance during the communication.

Alternatively or additionally, access point 110 may use transmit beamforming when the frames are transmitted to electronic device 112 (i.e., a spatial filtering technique that provides directional signal transmission or reception to achieve spatial selectivity). Therefore, at least some of the frames may include sounding information. In these embodiments, therefore, the feedback may include beamforming steering matrices (and, more generally, explicit feedback). Furthermore, access point 110 may use the beamforming steering matrices to determine phases associated with the antennas, which are subsequently used during communication with electronic device 112. For example, the signal-to-interference-plus-noise (SINR) information from the beamforming feedback may be used to select the phases, and the phases may be used by access point 110 for explicit beamforming.

In some embodiments, the antenna patterns selected for the antennas may be optimal. For example, the antenna patterns may achieve approximately optimal communication performance during communication with electronic device 112, such as communication performance within 5, 10 or 20% of the maximum communication performance.

In this way, using the search technique access point 110 may quickly determine appropriate antenna patterns and/or phases for the antennas, with suitable or optimal communication performance with electronic device 112.

We now describe embodiments of the method. FIG. 2 presents a flow diagram illustrating a method 200 for searching through a set of antenna patterns, which may be performed by an access point, such as access point 110 in FIG. 1. During operation, the access point may search through the set of antenna patterns that includes possible antenna patters for the antennas. In particular, the access point may transmit frames to an electronic device (operation 210).

While transmitting the frames, the access point may vary, over the set of antenna-patterns, an antenna pattern (operation 212) of a first antenna in the access point that is being processed, and may set remaining antennas (operation 212) in the access point that have not been processed to a fixed antenna pattern (such as an omnidirectional antenna pattern).

Next, the access point may receive feedback (operation 214) from the electronic device. For example, the feedback may include acknowledgements frames that indicate whether transmitted frames were successfully received by the electronic device. Alternatively or additionally, the feedback may include information that specifies communication performance during the communication. In some embodiments, the feedback includes beamforming steering matrices. Thus, the access point may use transmit beamforming when the frames are transmitted (operation 210) to the electronic device. Consequently, at least some of the frames transmitted may include sounding information.

Note that access point may use the beamforming steering matrices to optionally determine phases (operation 216) associated with the antennas, which may be subsequently used during communication with the electronic device. For example, the determined phases of the electrical signals applied to the first antenna may be used when transmitting information to the electronic device using the first antenna. In addition, the determined phases may be used when receiving electronical signals from the electronic device. The phases may ensure coherent or additive linear superposition of the electromagnetic signals transmitted by the antennas at the electronic device.

Based on the feedback, the access point may select a first antenna pattern (operation 218) for the first antenna. Note that the antenna pattern selected for the first antenna may be optimal. For example, the antenna pattern may achieve approximately optimal communication performance during communication with the electronic device. Thus, the antenna pattern may achieve approximately optimal communication performance, such as within 5, 10 or 20% of the maximum communication performance (e.g., the maximum data rate, throughput, RSSI, etc.).

Then, the transmitting (operation 210), the varying (operation 212), the receiving (operation 214), the optional determining (operation 216) and the selecting (operation 218) may be repeated, independently (e.g., one at a time), for the remaining antennas (operation 220), while a subset of the antennas (which includes the first antenna) that have already processed are set to their selected antenna patterns (operation 222) and another subset of the antennas that have not already processed may set to the fixed antenna pattern (operation 222).

In some embodiments of method 200, there may be additional or fewer operations. For example, method 200 may include one or more iterations of the transmitting (operation 210), the varying (operation 212), and the receiving (operation 214) for a given antenna that is being processed or optimized until a desired confidence interval is obtained (such as 95% confidence). Furthermore, the order of the operations may be changed, and/or two or more operations may be combined into a single operation.

Alternatively, when the operations are repeated, the antennas that have been processed may be set to the fixed antenna pattern. After the antenna patterns for all the antennas have been selected, then these antenna patterns may be used when the access point is communicating frames. In some embodiments, at least one or more of the antennas are set to one or more different fixed antenna patterns during method 200.

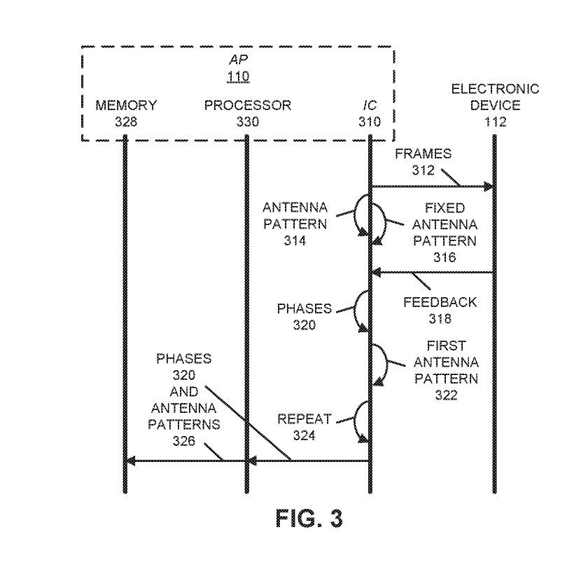

Embodiments of the search technique are further illustrated in FIG. 3, which presents a drawing illustrating communication between access point 110 and electronic device 112 in accordance with some embodiments. In particular, an interface circuit (IC) 310 in access point 110 may transmit frames 312 to electronic device 112 in the WLAN. As interface circuit 310 transmits frames 312, it may vary, over a set of antenna patterns, an antenna pattern 314 of a first antenna in access point 110 that is being processed and it may set remaining antennas in access point 110 that have not been processed to a fixed antenna pattern 316.

Next, interface circuit 310 may receive feedback 318 from electronic device 112. This feedback may be implicit, such as acknowledgements frames that indicate whether transmitted frames 312 were successfully received by electronic device 112 (or the absence of acknowledgment frames that indicate that frames 312 were not successfully received). Alternatively or additionally, feedback 318 may be explicit, such as information that specifies communication performance between access point 110 and electronic device 112 (e.g., a reported RSSI value, data rate and/or throughput) and/or information that specifies beamforming steering matrices that are optionally determined by electronic device 112 when frames 312 are transmitted using transmit beamforming and include sounding information. Note that interface circuit 310 may use the beamforming steering matrices to optionally determine phases 320 associated with the antennas, which may be subsequently used during communication with electronic device 112.

Based on feedback 318, interface circuit 310 may select a first antenna pattern 322 for the first antenna.

Then, interface circuit 310 may repeat 324 the transmitting, the varying, the receiving, the optional determining and the selecting independently (e.g., one at a time) for the remaining antennas, while a subset of the antennas (which includes the first antenna) that have already processed are set to their selected antenna patterns and another subset of the antennas that have not already processed may be set to the fixed antenna pattern. Note that the selected antenna patterns 326 (which include the first antenna pattern 322) and/or optional phases 320 may be stored in memory 328 for subsequent use during communication with electronic device 112.

While the preceding examples illustrated the search technique as being performed by access point 110, in other embodiments in which electronic device 112 has multiple antennas, electronic device 112 performs the search technique. Moreover, while FIG. 3 illustrates interface circuit 310 performing operations in the search technique, in other embodiments at least some of the operations are performed by processor 330 that executes a program module or software.

In some embodiments, the search technique is performed once, is repeated periodically and/or is performed as needed (e.g., based on the communication performance). Thus, the search technique may be performed every 1, 5, 10 or 30 min. Alternatively or additionally, the search technique may be performed when the throughput decreases by 30 or 50% from the maximum throughput.

In an exemplary embodiment, a transmit or receive antenna pattern (or antenna radiation pattern) of an access point may be adapted or changed using pattern shapers (such as reflectors) in one or more antennas (or antenna elements), which can be independently and selectively electrically coupled to ground to steer the transmit antenna pattern in different directions. Thus, if the one or more antennas include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of an electronic device that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

In some embodiments, there are 7 different antenna pattern configurations and the access point includes four antennas. Thus, the set of antenna patterns may include 7⁴ or 2401 possible or potential antenna patterns.

As discussed previously, memory constraints often require that one of the four antennas have an omnidirectional antenna pattern, so that the size of the set of antenna patterns is reduced when determining or selecting the antenna patterns for the other three antennas. However, this approach may result in suboptimal communication performance and it still may be time consuming to select the antenna patterns.

Instead, in the search technique the antenna patterns for the four antennas may be optimized individually (and independently of each other) using beamforming and acknowledgment frames.

When beamforming from a multi-chain access point is used to transmit to a single-chain client or electronic device, any increase in signal strength from any individual chain towards the client will improve the signal quality at the client. In turn, this means that antenna patterns of the different client chains can be optimized independently of each other. This may not necessarily be the case in a non-beamformed transmission, because the signal from the various chains may be out of phase with each other. Consequently, in the former case, the transmit antennas patterns may be optimized sequentially to get an optimum for the entire set of antenna patterns. Independent optimization allows for a much more efficient antenna-pattern search technique, which allows for a much larger set of antenna patterns. Therefore, this search technique may allow greater gain to be obtained from the entire set of antenna patterns.

For example, in embodiments where the set of antenna pattern (which may be arranged as tuples) includes 2401 potential antenna patterns, without transmit beamforming the search space may need to be searched jointly, which may require the that the total number of possible antenna patterns be limited to four different antenna patterns on each of three antennas, and the omnidirectional antenna pattern (which is used as an example of the fixed antenna pattern) may be used on the fourth antenna for a total of 64 possible antenna patterns.

However, using the search technique with transmit beamforming, each chain or antenna can be searched independently and sequentially to select the best of seven possible antenna patterns on one chain, and then the best of seven possible antenna patterns on the next chain, continuing until reaching the best antenna patterns out of the entire search space of 2401 antenna patterns (i.e., the set of antenna patterns). The amount of searching in this approach is 4.7 or 28, which is even less than the 64 possible antenna patterns used in existing search techniques, yet the entire set of antenna patterns has been searched.

Thus, in some embodiments, during the search technique antennas 2-4 may transmit frames to an electronic device using an omnidirectional antenna pattern (and, more generally, a fixed antenna pattern that may or may not be included in the possible antenna patterns), and antenna 1 may transmit frames to the electronic device while the antenna pattern of antenna 1 is varied over the seven possible antenna patterns. Then, based on the feedback from the electronic device, the access point may select a first antenna pattern for antenna 1.

Moreover, antennas 3-4 may transmit frames to the electronic device using an omnidirectional antenna pattern, antenna 1 may transmit frames to the electronic device using the first antenna pattern, and antenna 2 may transmit frames to the electronic device while the antenna pattern of antenna 2 is varied over the seven possible antenna patterns. Then, based on the feedback from the electronic device, the access point may select a second antenna pattern for antenna 2.

Next, antenna 4 may transmit frames to the electronic device using an omnidirectional antenna pattern, antenna 1 may transmit frames to the electronic device using the first antenna pattern, antenna 2 may transmit frames to the electronic device using the second antenna pattern, and antenna 3 may transmit frames to the electronic device while the antenna pattern of antenna 3 is varied over the seven possible antenna patterns. Then, based on the feedback from the electronic device, the access point may select a third antenna pattern for antenna 3.

Furthermore, antenna 1 may transmit frames to the electronic device using the first antenna pattern, antenna 2 may transmit frames to the electronic device using the second antenna pattern, antenna 3 may transmit frames to the electronic device using the third antenna pattern, and antenna 4 may transmit frames to the electronic device while the antenna pattern of antenna 4 is varied over the seven possible antenna patterns. Then, based on the feedback from the electronic device, the access point may select a fourth antenna pattern for antenna 4.

As noted previously, in some embodiments transmit beamforming is used to align the phases of the antennas.

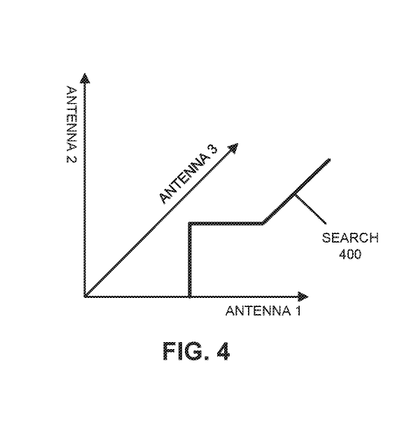

Thus, using the search technique, the access point may look at 28 antenna patterns instead of 2401 antenna patterns. This approach is shown in FIG. 4, which presents a drawing illustrating a search 400 through a set of antenna patterns that includes possible antenna patterns for three antennas in accordance with some embodiments.

In general, transmit beamforming may be needed to avoid having systematically search the entire space or the entire set of antenna patterns. However, if the electronic device (or the recipient) is moving, the antenna phases may be random (which may reflect the randomness in the environment). In these embodiments, the search technique may be performed without using transmit beamforming, such as by using implicit feedback.

In some embodiments, the access point shares the selected antenna patterns with another electronic device and/or another access point in proximity (such as in the same RF environment). In conjunction with the location of the access point and/or the electronic device (which may be determined using wireless communication, a local positioning system, a Global positioning system and/or is predefined), the other electronic device and/or the other access point may use the selected antenna patterns to determine which antenna patterns the other electronic device and/or the other access point should use. Therefore, during communication, the access point may provide information that specifies a location of the access point and/or the selected antenna patterns that the access point is currently using.

We now describe embodiments of an electronic device, which may perform at least some of the operations in the search technique. FIG. 5 presents a block diagram illustrating an electronic device 500 in accordance with some embodiments, such as one of access point 110, electronic device 112, or optional controller 114. This electronic device includes processing subsystem 510, memory subsystem 512, and networking subsystem 514. Processing subsystem 510 (which may be a ‘means for processing’) includes one or more devices configured to perform computational operations. For example, processing subsystem 510 can include one or more microprocessors, ASICs, microcontrollers, programmable-logic devices, and/or one or more digital signal processors (DSPs).

Memory subsystem 512 includes one or more devices for storing data and/or instructions for processing subsystem 510 and networking subsystem 514. For example, memory subsystem 512 can include dynamic random access memory (DRAM), static random access memory (SRAM), and/or other types of memory. In some embodiments, instructions for processing subsystem 510 in memory subsystem 512 include: one or more program modules or sets of instructions (such as program module 522 or operating system 524), which may be executed by processing subsystem 510. Note that the one or more computer programs may constitute a computer-program mechanism. Moreover, instructions in the various modules in memory subsystem 512 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 510.

In addition, memory subsystem 512 can include mechanisms for controlling access to the memory. In some embodiments, memory subsystem 512 includes a memory hierarchy that comprises one or more caches coupled to a memory in electronic device 500. In some of these embodiments, one or more of the caches is located in processing subsystem 510.

In some embodiments, memory subsystem 512 is coupled to one or more high-capacity mass-storage devices (not shown). For example, memory subsystem 512 can be coupled to a magnetic or optical drive, a solid-state drive, or another type of mass-storage device. In these embodiments, memory subsystem 512 can be used by electronic device 500 as fast-access storage for often-used data, while the mass-storage device is used to store less frequently used data.

Networking subsystem 514 (which may be a ‘means for communicating’) includes one or more devices configured to couple to and communicate on a wired and/or wireless network (i.e., to perform network operations), including: control logic 516, an interface circuit 518 and one or more antennas 520 (or antenna elements). (While FIG. 5 includes one or more antennas 520, in some embodiments electronic device 500 includes one or more nodes, such as nodes 508, e.g., a pad, which can be coupled to the one or more antennas 520. Thus, electronic device 500 may or may not include the one or more antennas 520.) For example, networking subsystem 514 can include a Bluetooth™ networking system, a cellular networking system (e.g., a 3G/4G network such as UMTS, LTE, etc.), a universal serial bus (USB) networking system, a networking system based on the standards described in IEEE 802.11 (e.g., a Wi-Fi® networking system), an Ethernet networking system, and/or another networking system.

Networking subsystem 514 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 500 may use the mechanisms in networking subsystem 514 for performing simple wireless communication between the electronic devices, e.g., transmitting advertising or beacon frames and/or scanning for advertising frames transmitted by other electronic devices as described previously.

Within electronic device 500, processing subsystem 510, memory subsystem 512, and networking subsystem 514 are coupled together using bus 528. Bus 528 may include an electrical, optical, and/or electro-optical connection that the subsystems can use to communicate commands and data among one another. Although only one bus 528 is shown for clarity, different embodiments can include a different number or configuration of electrical, optical, and/or electro-optical connections among the subsystems.

In some embodiments, electronic device 500 includes a display subsystem 526 for displaying information on a display, which may include a display driver and the display, such as a liquid-crystal display, a multi-touch touchscreen, etc.

Electronic device 500 can be (or can be included in) any electronic device with at least one network interface. For example, electronic device 500 can be (or can be included in): a desktop computer, a laptop computer, a subnotebook/netbook, a server, a tablet computer, a smartphone, a cellular telephone, a smartwatch, a consumer-electronic device, a portable computing device, an access point, a transceiver, a router, a switch, communication equipment, an access point, a controller, test equipment, and/or another electronic device.

Although specific components are used to describe electronic device 500, in alternative embodiments, different components and/or subsystems may be present in electronic device 500. For example, electronic device 500 may include one or more additional processing subsystems, memory subsystems, networking subsystems, and/or display subsystems. Additionally, one or more of the subsystems may not be present in electronic device 500. Moreover, in some embodiments, electronic device 500 may include one or more additional subsystems that are not shown in FIG. 5. Also, although separate subsystems are shown in FIG. 5, in some embodiments some or all of a given subsystem or component can be integrated into one or more of the other subsystems or component(s) in electronic device 500. For example, in some embodiments program module 522 is included in operating system 524 and/or control logic 516 is included in interface circuit 518.

Moreover, the circuits and components in electronic device 500 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 514. The integrated circuit may include hardware and/or software mechanisms that are used for transmitting wireless signals from electronic device 500 and receiving signals at electronic device 500 from other electronic devices. Aside from the mechanisms herein described, radios are generally known in the art and hence are not described in detail. In general, networking subsystem 514 and/or the integrated circuit can include any number of radios. Note that the radios in multiple-radio embodiments function in a similar way to the described single-radio embodiments.

In some embodiments, networking subsystem 514 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used a Wi-Fi communication protocol as an illustrative example, in other embodiments a wide variety of communication protocols and, more generally, wireless communication techniques may be used. Thus, the search technique may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the search technique may be implemented using program module 522, operating system 524 (such as a driver for interface circuit 518) or in firmware in interface circuit 518. Alternatively or additionally, at least some of the operations in the search technique may be implemented in a physical layer, such as hardware in interface circuit 518.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. An access point, comprising:
nodes configured to couple to multiple antennas;
an interface circuit, coupled to the nodes, that is configured to communicate with an electronic device in a wireless local area network (WLAN), wherein the access point is configured to search through a set of antenna pattern that includes possible antenna patterns for the antennas, the search comprising the operations of:
while transmitting frames to the electronic device, varying, over the set of antenna patterns, an antenna pattern of a first antenna that is being processed and setting remaining antennas in the access point that have not been processed to a fixed antenna pattern;
receiving feedback received from the electronic device;
selecting a first antenna pattern for the first antenna based on the feedback; and
repeating the transmitting, the varying, the receiving and the selecting, independently, for the remaining antennas, while a subset of the antennas, which includes the first antenna, that have already processed are set to their selected antenna patterns and another subset of the antennas that have not already processed are set to the fixed antenna pattern or a different fixed antenna pattern.

2. The access point of claim 1, wherein the feedback includes acknowledgements frames that indicate whether transmitted frames were successfully received by the electronic device.

3. The access point of claim 1, wherein the feedback includes information that specifies communication performance during the communication.

4. The access point of claim 1, wherein the access point uses transmit beamforming when the frames are transmitted to the electronic device so that at least some of the frames include sounding information.

5. The access point of claim 4, wherein the feedback includes beamforming steering matrices.

6. The access point of claim 5, wherein the access point uses the beamforming steering matrices to determine phases associated with the antennas, which are subsequently used during communication with the electronic device.

7. The access point of claim 1, wherein the interface circuit performs at least some of the operations performed by the access point during the search.

8. The access point of claim 1, wherein the access point further comprises:
a processor, coupled to the interface circuit and memory, configured to execute a program module; and
the memory, coupled to the processor, configured to store the program module, wherein the program module includes instructions for at least some of the operations performed by the access point during the search.

9. The access point of claim 1, wherein the antenna patterns selected for the antennas achieve approximately optimal communication performance during communication with the electronic device.

10. The access point of claim 1, wherein the access point further comprises the antennas.

11. A method for searching through a set of antenna patterns that includes possible antenna patterns for antenna in an access point, the method comprising:
while transmitting frames to an electronic device, varying, over the set of antenna patterns, an antenna pattern of a first antenna that is being processed and setting remaining antennas in the access point that have not been processed to a fixed antenna pattern;
receiving feedback received from the electronic device;
selecting a first antenna pattern for the first antenna based on the feedback; and
repeating the transmitting, the varying, the receiving and the selecting, independently, for the remaining antennas, while a subset of the antennas, which includes the first antenna, that have already processed are set to their selected antenna patterns and another subset of the antennas that have not already processed are set to the fixed antenna pattern or a different fixed antenna pattern.

12. The method of claim 11, wherein the feedback includes acknowledgements frames that indicate whether transmitted frames were successfully received by the electronic device.

13. The method of claim 11, wherein the feedback includes information that specifies communication performance during the communication.

14. The method of claim 11, wherein the access point uses transmit beamforming when the frames are transmitted to the electronic device so that at least some of the frames include sounding information.

15. The method of claim 14, wherein the feedback includes beamforming steering matrices.

16. The method of claim 15, wherein the method further comprises determining phases associated with the antennas based on the beamforming steering matrices, which are subsequently used during communication with the electronic device.

17. The method of claim 11, wherein the antenna patterns selected for the antennas achieve approximately optimal communication performance during communication with the electronic device.

18. A computer-program product for use in conjunction with an access point, the computer-program product comprising a non-transitory computer-readable storage medium and a computer-program mechanism embedded therein to search through a set of antenna patterns that includes possible antenna patterns for antennas in an access point, the computer-program mechanism including:
instructions for varying, over the set of antenna patterns, an antenna pattern of a first antenna that is being processed while transmitting frames to an electronic device, and setting remaining antennas in the access point that have not been processed to a fixed antenna pattern;
instructions for receiving feedback received from the electronic device;
instructions for selecting a first antenna pattern for the first antenna based on the feedback; and
instructions for repeating the transmitting, the varying, the receiving and the selecting, independently, for the remaining antennas, while a subset of the antennas, which includes the first antenna, that have already processed are set to their selected antenna patterns and another subset of the antennas that have not already processed are set to the fixed antenna pattern or a different fixed antenna pattern.

19. The computer-program product of claim 18, wherein the feedback includes acknowledgements frames that indicate whether transmitted frames were successfully received by the electronic device.

20. The computer-program product of claim 18, wherein the access point uses transmit beamforming when the frames are transmitted to the electronic device so that at least some of the frames include sounding information;
wherein the feedback includes beamforming steering matrices; and
wherein the computer-program mechanism further comprises instructions for determining phases associated with the antennas based on the beamforming steering matrices, which are subsequently used during communication with the electronic device.
